(19) United States
(12) Patent Application Publication
(10) Pub. No.: US 2024/0351110 A1
(43) Pub. Date: Oct. 24, 2024

(54) METHOD FOR MACHINING A WHEEL HUB ASSEMBLY FOR A VEHICLE

(71) Applicant: AKTIEBOLAGET SKF, GOTEBORG (SE)

(72) Inventor: Davide Antonio OLIVIERI, Torino (IT)

(21) Appl. No.: 18/634,048

(22) Filed: Apr. 12, 2024

(30) Foreign Application Priority Data
Apr. 20, 2023 (IT) 102023000007707

(51) Int. Cl. B23B 5/02

(52) U.S. Cl. CPC B23B 5/02

(57) ABSTRACT

A method for machining a wheel hub assembly for a vehicle includes providing a radially outer ring having a first radial flange, a radially inner hub having a second radial flange facing the first flange, and a plurality of rolling elements disposed between and rotatably coupling the outer ring and the hub. The hub is rotated simultaneously and asynchronously about the outer ring while machining a front surface of the second flange, which faces away from the first flange, and while rotating the outer ring about an axis of rotation of the wheel hub assembly, so as to form a machined surface of the second flange. The machined surface of the second flange is perpendicular to the axis of rotation and parallel to a front face of the first flange opposite to the front face of the second flange.

### CROSS-REFERENCE

This application claims priority to Italian patent application no. 102023000007707 filed on Apr. 20, 2023, the contents of which are fully incorporated herein by reference.

### BACKGROUND OF THE INVENTION

The present invention relates to bearings, and more particularly to a method for machining a wheel hub assembly for a vehicle including a rolling bearing.

A typical modern wheel hub assembly for vehicles consists of a “bi-flanged” or “third generation” rolling bearing. Such a rolling bearing includes an inner ring forming the hub of the wheel hub assembly, which is provided with a flange for receiving a vehicle brake disk during use, and an outer ring provided with a flange for mounting to a vehicle suspension assembly. The inner ring may also include a small inner ring (SIR) on which is formed one of the raceways for the rolling elements that are interposed or disposed between the inner ring and the outer ring such that the inner and outer rings are relatively rotary with low friction.

The inner ring and the outer ring are each provided with respective opposing radial ring flanges that face one another. As a result of machining tolerances, there may be small defects in parallelism and/or perpendicularity in relation to the axis of rotation of the wheel hub assembly between the opposing front faces of the flanges.

The absence of perfect perpendicularity between the entire face of the flange of the inner ring or hub, which is intended to receive the brake disk in use, and the axis of rotation of the wheel hub assembly, is referred to as “axial runout”. This axial runout may cause early and irregular brake pad wear and undesired noise and vibration during use of the wheel hub assembly.

The issue of axial runout in the wheel hub assembly was addressed by the machining method disclosed in European patent publication EP1196261B1, the contents of which are incorporated herein by reference. However, the problem of ensuring substantial parallelism between the opposing faces of the opposing flanges of the wheel hub assembly, which form the connection interfaces with the vehicle wheel (and to the brake disk) and to the suspension upright, remains unresolved. Under current wheel hub manufacturing processes, ensuring substantial parallelism between these surfaces requires additional machining, which increases the cost and time required to fabricate wheel hub assemblies.

### SUMMARY OF THE INVENTION

The present invention is a method of machining a wheel hub assembly for a vehicle, the wheel hub assembly including a third-generation rolling bearing, that provides, with a single machine-tool operation, reduced or substantially absent axial runout and reduced or substantially absent parallelism error between the flange configured to receive the vehicle wheel with the brake disk and the flange configured to couple or connect with the vehicle suspension.

As used in the present application, the term “substantially absent” means a parallelism or perpendicularity error of less than or equal to four hundredths of a millimeter (0.04 mm).

The present invention therefore provides a method of machining a wheel hub assembly for a vehicle, as defined in the attached claims.

The present invention also relates to a wheel hub assembly obtained using such a machining method.

### BRIEF DESCRIPTION OF THE SEVERAL VIEWS OF THE DRAWINGS

Further features and advantages of the present invention are set out in the description below with reference to the attached FIGURE, which illustrate, schematically and out of scale only, a non-limiting embodiment of a wheel hub assembly obtained using the machining method, as well as the main steps of the machining method according to the invention. In the drawings:

FIG. 1 is a cross-sectional view of a wheel hub assembly shown mounted to machine spindles during a machining method of the present invention.

### DETAILED DESCRIPTION OF THE INVENTION

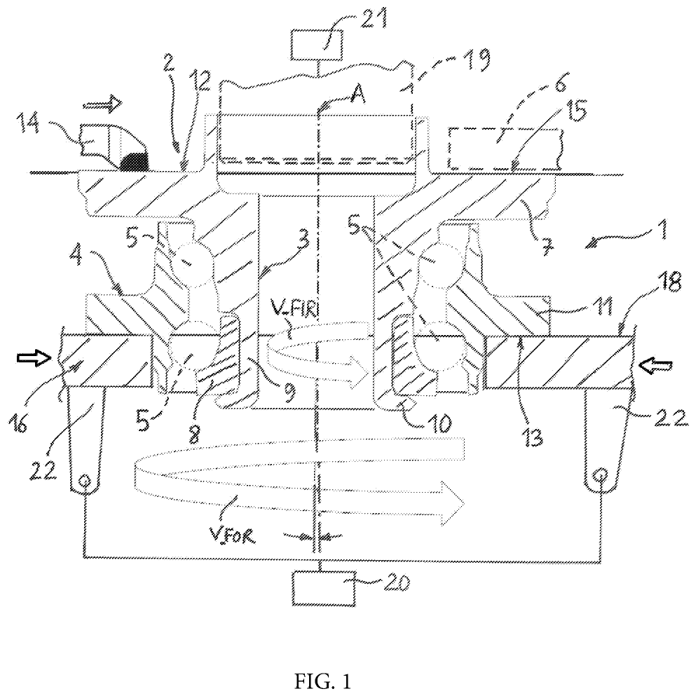

In FIG. 1, reference sign 1 indicates the whole of a substantially known wheel hub assembly. In particular, according to the preferred embodiment of the invention, illustrated in a non-limiting manner herein, the wheel hub assembly 1 consists of a “third generation” rolling bearing 2, which includes a radially inner ring or hub 3, a radially outer ring 4, and a plurality of rolling elements 5 seated or disposed between the inner ring 3 and the outer ring 4 to make them relatively rotary about an axis of rotation “A”. The axis of rotation A forms or provides the axis of rotation of the wheel hub assembly 1, a known brake disk 6 being arranged on the wheel hub assembly 1 perpendicular to the axis A during use of the wheel hub assembly 1. In FIG. 1, the brake disk 6 is illustrated only partially and only with hatching, exclusively by way of example.

In the non-limiting example depicted in FIG. 1, the inner ring 3 of the bearing 2 forms the hub of the wheel hub assembly 1 and includes an integral annular flange 7 arranged on the radial outside or outer side of the ring 3. The inner ring 3 also includes a small inner ring (“SIR”) 8 press-fitted onto a cylindrical end 9 of the inner ring 3 on an axial side opposite to the flange 7. The SIR 8 is held in place or retained by a collar 10 formed by the plastic deformation of a terminal edge of the cylindrical end 9 using a known forming process, which is not described here for the sake of simplicity.

The outer ring 4 of the bearing 2 is mounted coaxially about the inner ring 3 and has an integral flange 11 arranged on the axial side opposite to the flange 7 such that the flanges 7 and 11 are facing. The flange 7 of the inner ring 3 has a flat front surface or face 12 that faces away from the flange 11. The flange 11 of the outer ring 4 has a flat, opposing front surface or face 13 that faces away from the flange 7, the flange 11 being intended to be coupled in a known manner to a vehicle suspension assembly during use of the wheel hub assembly 1. Preferably, the flange 11 is connectable or coupleable with a vehicle suspension upright, such a suspension upright being generally known and not depicted in FIG. 1 for the sake of simplicity.

As illustrated schematically in FIG. 1, the present invention comprises a method for machining the wheel hub assembly 1 to compensate for any misalignment, shown schematically and out of scale in FIG. 1, and/or any axial runout caused by machining tolerances and/or unwanted deformation.

The method comprises a first step of providing the wheel hub assembly 1 as described above, already fully assembled, therefore consisting of a rolling bearing 2 including a radially outer ring 4, which is provided with a first flange 11 on the radial outside of the ring 4, and a radially inner ring or hub 3 provided with a second flange 7 on the radial outside of the hub 3 so as to face the first flange 11, the outer ring 4 and the hub 3 being relatively rotatable by a set of a plurality of rolling elements 5 interposed or disposed between the ring 4 and hub 3.

The machining method according to the present invention further comprises a second step that includes rotating the hub 3 with respect to the outer ring 4 and simultaneously using a known tool 14 (e.g., a cutting tool such as a tool bit) to mechanically machine the front face or surface 12 of the second flange 7, the surface 12 facing away from the first flange 11.

The machining of the surface 12 is executed using the tool 14 by means of stock removal, as described in EP1196261B1, the contents of which have been incorporated into this document by reference as discussed above. This machining operation, which essentially involves “facing” the surface or face 12, is executed so as to provide, once machining has been completed, a machined surface 15 (shown schematically on the right-hand side of FIG. 1) that is designed or configured to receive a vehicle brake disk 6 during use of the wheel hub assembly 1. As such, the machined surface 15 is/must be oriented perpendicular to the axis of rotation A of the wheel hub assembly 1.

According to a main aspect of the invention, the machining method of the present invention illustrated in FIG. 1 also comprises a third step that involves also rotating the outer ring 4 simultaneously with or during the rotation of the hub 3 and asynchronously with respect to the hub 3.

The term “asynchronously” as used herein means that the velocity of rotation of the two rings, specifically the ring 3 (hub or inner ring) and the ring 4 (outer ring), are not identical, but that, when considered as vectors, differ from one another in magnitude and/or angular direction. However, such asynchronous relative rotation of the hub 3 and the outer ring 4 occur simultaneously as discussed above.

As a result of the third step of the present method, which is additional to the subject matter of EP1196261B1, the machined surface 15 has been determined to be oriented not only substantially perpendicular to the axis of rotation A of the wheel hub assembly 1, but also substantially parallel to the front face 13 of the first flange 11, the face 13 being opposite to the front face 12 (i.e., the surfaces 12 and 13 face away from each other and face in opposing directions along the axis of rotation A) and the face 13 being intended (and configured) to be coupled or connected in a known manner to a vehicle suspension upright during use of the wheel hub assembly 1.

According to an aspect of the method according to the present invention, the hub 3 is rotated at a first angular velocity V_FIR, shown schematically by an arrow in FIG. 1, that is different from a second angular velocity V_FOR, which is also shown schematically by another arrow in FIG. 1, at which the outer ring 4 is rotated simultaneously with rotation of the hub 3.

According to one embodiment of the present invention, the first angular velocity V_FIR is different from the second angular velocity V_FOR in rotational direction only. That is, the hub 3 may be rotated in any desired direction of rotation, for example clockwise, but opposite to the direction of rotation V_FOR of the outer ring 4, which is for example driven counterclockwise, but each one of the hub 3 and the ring 4 are rotated at the same magnitude or speed of rotation.

According to another embodiment of the present invention, the first angular velocity V_FIR is different from the second angular velocity V_FOR in magnitude only. In other words, the first angular velocity V_FIR has a magnitude with a first value ω1, expressed in rpm (rotations per minute) and the second angular velocity V_FOR has a magnitude with a second value ω2, expressed in rpm, which is different from the first value.

The two different embodiments of the present invention described above may be implemented separately, alternatively or simultaneously, i.e. together, rotating the hub 3 at a velocity V_FIR different from the velocity V_FOR at which the outer ring 4 is rotated both in magnitude and in rotational or angular direction.

In all cases, however, according to an important aspect of the present invention, the first value ω1 of the magnitude of the angular velocity of rotation V_FIR of the hub 3 and the second value ω2 of the magnitude of the angular velocity of rotation V_FOR of the outer ring 4 are selected such that the first angular velocity V_FIR is never an integer multiple of the second angular velocity V_FOR. It has been determined that avoiding rotation of the hub 3 and the outer ring 4 at different speeds which are integer multiples of each other prevents the creation of resonance phenomena during the asynchronous motion of the two rings 3 and 4.

According to another important aspect of the present invention, the first velocity of rotation V_FIR and the second velocity of rotation V_FOR are also chosen or selected to satisfy the following relationship:

$$V\_FIR - V\_FOR < 2000 rpm \qquad [ 1 ]$$

In other words, the first velocity of rotation V_FIR and the second velocity of rotation V_FOR are selected such that the difference between the two velocities is less than two thousand rotations per minute (2000 rpm).

According to a further aspect of the method according to the present invention, during execution of the second and third steps described above, which occur simultaneously, the front face 13 of the flange 11 of the outer ring 4 is arranged perpendicular to the axis of rotation A of the wheel hub assembly 1. This arrangement is preferably achieved by coupling a machine spindle 16 to the outer ring 4, the machine spindle 16 being used to rotate the outer ring 4 relative to and simultaneously with the hub 3.

The machine spindle 16 is provided with a reference surface 18 perpendicular to its axis of rotation, which is coincident with the axis of rotation A, and configured to receive in abutment the front face 13 of the flange 11.

During execution or performance of the second and third steps, the hub 3 is also rotated about the outer ring 4 by means of a second machine spindle 19 arranged substantially coaxially with the first machine spindle 16.

Each spindle 16, 19 is fitted or provided with a separate motor 20, 21, respectively, which are illustrated only schematically as two blocks in FIG. 1, such that the motor 20 rotatably drives the spindle 16 and the motor 21 rotatably drives the spindle 19. Furthermore, the spindle 16 is preferably fitted or provided with three jaws 22, which are arranged or spaced circumferentially apart by an angular distance of 120° in relation to each other (only two of which are shown schematically in the attached FIGURE). The three jaws 22 may be clamped to the outer ring 4 in the direction of the arrows to rotate the ring 4 in the desired direction and at the desired speed.

According to the present invention, once the above-described machining method has been completed, a wheel hub assembly 1 for a vehicle is provided in which the front face 12 of a radial flange 7, which is integral with a hub or inner ring 3 of a rolling bearing 2 forming part of the wheel hub assembly 1, has a machined surface 15 that is oriented substantially perpendicular to an axis of rotation A of the wheel hub assembly 1 and is simultaneously substantially parallel to the front face 13 of a radial flange 11 integral with an outer ring 4 of the rolling bearing 2, the front face 13 of the radial flange 11 being opposite to and facing the flange 7 of the hub 3. All of the aims of the present invention are thus achieved.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

I claim:

1. A method for machining a wheel hub assembly for a vehicle, the method comprising the steps of:
providing a wheel hub assembly with a rolling bearing including a radially outer ring having a first flange on a radially outer side of the outer ring and a radially inner hub having a second flange on a radially outer side of the hub, the second flange facing the first flange, and a plurality of rolling elements interposed between the outer ring and the hub such that the outer ring and the hub are relatively rotatable;
rotating the hub around the outer ring and while simultaneously machining a front surface of the second flange with a tool, the front surface facing away from the first flange, so as to provide a machined surface configured to receive a brake disc of a vehicle during use of the wheel hub assembly, the machined surface of the second flange being oriented perpendicular to a rotation axis of the wheel hub assembly; and
rotating the outer ring simultaneously with, and asynchronously with respect to, the rotation of the hub so that the machined surface of the second flange is also substantially parallel to a front face of the first flange opposite to the front face of the second flange.

2. The machining method according to claim 1, wherein the hub is rotated at a first angular velocity and the outer ring is rotated at a second angular velocity simultaneously with the rotation of the hub, the first angular velocity being different than the second angular velocity.

3. The machining method according to claim 2, wherein the first angular velocity has a direction different from a direction of the second angular velocity such that the hub is rotated in a direction of rotation opposite to a direction of rotation of the outer ring.

4. The method according to claim 2, wherein the first angular velocity has a magnitude different than a magnitude of the second angular velocity.

5. The machining method according to claim 4, wherein the first angular velocity has a first value expressed in rotations per minute and the second angular velocity has a second value expressed in rotations per minute, the second value being different from the first value.

6. The machining method according to claim 5, wherein the first value of the angular velocity of the hub and the second value of the angular velocity of the outer ring are selected such that the first angular velocity is not an integer multiple of the second angular velocity.

7. The machining method according to claim 2, wherein the first angular velocity of rotation (V_FIR) and the second angular velocity of rotation (V_FOR) are selected so as to satisfy the relationship: V_FIR-V_FOR<2,000 rpm.

8. The machining method according to claim 1, wherein:
the outer ring is coupled with a machine spindle during the step of rotating the outer ring such that the spindle rotates the outer ring simultaneously with the hub; and
during the step of rotating the hub and during the step of rotating the outer ring, the front face of the first flange is arranged perpendicular to the axis of rotation of the wheel hub assembly and to the axis of rotation of the machine spindle coupled with the outer ring.

9. The machining method according to claim 8, wherein the machine spindle has a reference surface perpendicular to an axis of rotation of the machine spindle and configured to receive in abutment the front face of the first flange of the outer ring.

10. The machining method according to claim 9, wherein:
the hub is coupled with a second machine spindle during the step of rotating the hub, the second machine spindle being arranged coaxial with the first machine spindle; and
the first spindle is provided with a motor for rotating the first spindle and the second spindle is provided with another motor for rotating the second spindle.

11. A wheel hub assembly for a vehicle obtained by the machining method according to claim 1, wherein:
the first flange is integrally formed with and extends radially outwardly from the outer ring;
the second flange is integrally formed with and extends radially outwardly from the hub; and
the front face of the second flange of the hub has a machined surface oriented substantially perpendicular to an axis of rotation of the wheel hub assembly and is simultaneously substantially parallel to the front face of the first flange.
